(19) United States
(12) Patent Application Publication
(10) Pub. No.: US 2026/0310288 A1
(43) Pub. Date: Oct. 8, 2026

(54) Anonymized Human Body Tracking

(71) Applicant: Disney Enterprises, Inc., Burbank, CA (US)

(72) Inventors: Michael Yaakov Becker, Poulsbo, WA (US); Ashley Rose Fornelli, Los Angeles, CA (US); Reuben A. Beauchamp, Pasadena, CA (US); Thomas O. Narey, JR., Downey, CA (US); Eric John Carmen Pagtaconan, Winnetka, CA (US); Tiffany Lee Harrison, Rancho Cucamonga, CA (US)

(21) Appl. No.: 19/173,636

(22) Filed: Apr. 8, 2025

(51) Int. Cl. G06F 3/01

(52) U.S. Cl. CPC G06F 3/012; G06F 3/017

(57) ABSTRACT

A system includes a computing platform communicatively coupled to a sensor and a display, the computing platform having a hardware processor, and a memory storing software code and a database comprising images corresponding to human physical features. The hardware processor executes the software code to detect, using sensor data, the presence of a user, identify, using the database and the sensor data, respective locations of physical features of the user, merge the locations of the physical features to determine a position data for at least one anonymized body segment of the user, track, using the sensor data, changes in the position data, and determine, based on tracking, at least one of the location of the user in relation to the sensor, or a posture or gesture by the user. The hardware processor further executes the software code to generate, using the display, an interactive effect responsive to the user.

### BACKGROUND

Providing interactive user experiences in public environments or in private environments in which guests have not been asked to waive privacy rights requires the careful balancing of two objectives that do not necessarily align. One of those objectives is to provide an interactive experience that is responsive in a relevant way to actions by a user participating in the interaction, without noticeable latency, that is to say, in “real-time.” The second objective is to ensure that the data utilized and/or retained in the process of providing such an interactive experience omits any personally identifiable information (PII) of any user participating in the interactive experience.

Although conventional feature recognition solutions make it possible to achieve the first objective, those solutions typically violate the constraints imposed by the second objective, i.e., user anonymity. Consequently, there is a need in the art for a fast and accurate human body tracking solution enabling real-time interactive responsiveness to human behavior while ensuring the anonymity of users participating in an interactive experience.

### BRIEF DESCRIPTION OF THE DRAWINGS

FIG. 1 shows a diagram of an anonymized human body tracking system, according to one implementation;

FIG. 2 shows a diagram of an exemplary software code suitable for use by an anonymized human body tracking system, according to one implementation;

FIG. 3A shows an exemplary environment in which anonymized human body tracking is used to support an interactive user experience, according to one implementation;

FIG. 3B shows an exemplary environment in which anonymized human body tracking is used to support an interactive user experience, according to another implementation; and

FIG. 4 shows a flowchart presenting an exemplary method for performing anonymized human body tracking, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, providing interactive user experiences in public environments or in private environments in which guests have not been asked to waive privacy rights requires the careful balancing of two objectives that do not necessarily align. One of those objectives is to provide an interactive experience that is responsive in a relevant way to actions by a user participating in the interaction, without noticeable latency, that is to say, in “real-time.” The second objective is to ensure that the data utilized and/or retained in the process of providing such an interactive experience omits any personally identifiable information (PII) of any user participating in the interactive experience. As also stated above, although conventional feature recognition solutions make it possible to achieve the first objective, those solutions typically violate the constraints imposed by the second objective, i.e., user anonymity. Consequently, there is a need in the art for a fast and accurate human body tracking solution enabling real-time interactive responsiveness to human behavior while ensuring the anonymity of users participating in an interactive experience.

The present application discloses systems and methods for performing anonymized human body tracking that address and overcome the drawbacks and deficiencies in the conventional art by enabling real-time interactive responsiveness to human behavior while ensuring the anonymity of users participating in an interactive experience. It is noted that, as defined for the purposes of the present application, “real-time” refers to the absence of humanly perceived latency between a user action and a system generated interactive response to that action.

It is further noted that the present anonymized human body tracking solution advances the state-of-the-art by averaging body features to preserve privacy and anonymity, can advantageously be executed using off-the-shelf equipment rather than bespoke technology while nevertheless enabling gesture detection as well as body tracking, and additionally determines body distance without access to actual distance/depth data. Moreover, the present anonymized human body tracking solution may advantageously be implemented as automated systems and methods. As used in the present application, the terms “automation,” “automated” and “automating” refer to systems and processes that do not require the participation of a human system operator. Thus, the methods described in the present application may be performed under the control of hardware processing components of the disclosed systems.

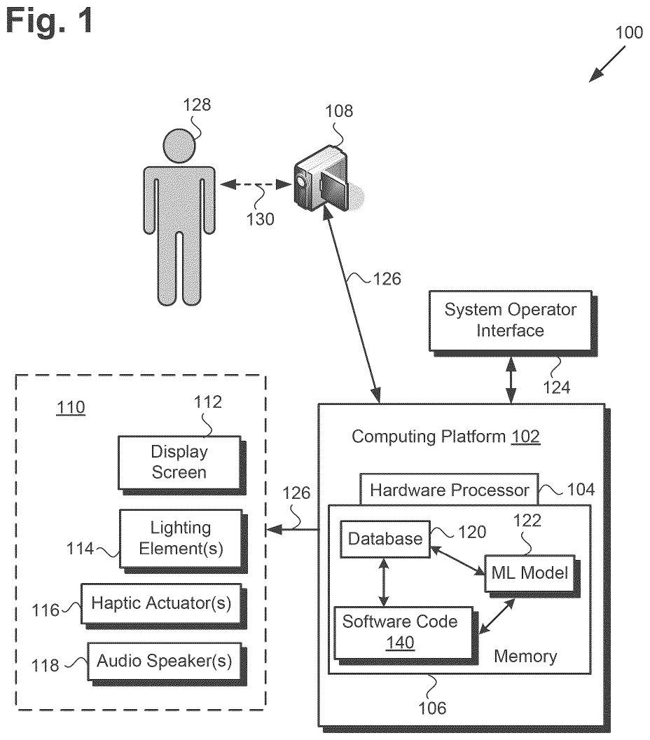

FIG. 1 shows a diagram of anonymized human body tracking system 100 (hereinafter also “system 100”), according to one implementation. As shown in FIG. 1, system 100 includes computing platform 102 communicatively coupled to sensor 108, shown as a red-green-blue (RGB) camera in FIG. 1, as well as to display 110, which may be a display system including display screen 112 and one or more lighting elements 114 (hereinafter “lighting element(s) 114”), one or more haptic actuators 116 (hereinafter “haptic actuator(s) 116”) and one or more audio speakers 118 (hereinafter “audio speaker(s) 118”). It is noted that, in some implementations, display 110 may be an augmented reality (AR) device or a virtual reality (VR) device.

As further shown in FIG. 1, computing platform 102 includes hardware processor 104 and memory 106 implemented as a computer-readable non-transitory storage medium. According to the exemplary implementation shown in FIG. 1, memory 106 stores software code 140, database 120 storing images corresponding respectively to human physical features, and trained machine learning (ML) model 122. Also shown in FIG. 1 are system operator interface 124 provided by system 100, user 128 anonymously tracked by system 100, communication links 126 between computing platform 102 and sensor 108 and between computing platform 102 and display 110, and distance 130 of user 128 from sensor 108.

It noted that, as defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as transformers, large-language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to an NN that utilizes multiple hidden layers between input and output layers, which may allow for learning based on features not explicitly defined in raw data. As used in the present application, a feature identified as an NN refers to a deep neural network.

Although the present application refers to software code 140, database 120 and trained ML model 122 as being stored in memory 106 for conceptual clarity, more generally, memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 140, from memory 106, while a GPU may be implemented to reduce the processing overhead of the CPU by performing computationally intensive graphics or other processing tasks. A TPU is an application-specific integrated circuit (ASIC) configured specifically for artificial intelligence (AI) applications such as ML modeling.

In some implementations, computing platform 102 may correspond to a computer server or a desktop computer, for example. In other implementations, computing platform 102 may take the form of any suitable mobile or stationary computing device or system that implements data processing capabilities sufficient to provide system operator interface 124 and perform the functionality ascribed to system 100. That is to say, in other implementations, computing platform 102 may take the form of a laptop computer, tablet computer, or smartphone, to name a few examples.

In some implementations, as shown in FIG. 1, system 100 may provide system operator interface 124. In those implementations, system operator interface 124 may be utilized by an operator of system 100 (system operator not shown in FIG. 1) to perform various debugging or control operations. System operator interface 124 may include a graphical user interface providing visual feedback of position data derived from the merging or averaging of individual features of user 128, as well as visual feedback regarding an interactive effect generated by system 100. In addition, in some implementations system operator interface 124 may enable control over which anonymized body segment or body segments of user 128 are to be tracked, enable control over a distance threshold used to determine the “presence” of user 128 and enable control of a location change or motion threshold used to detect an action, such as a gesture for example, by user 128.

Display screen 112 of display 110 may be a large, wall mounted or wall inset display screen, for example, or a free standing display screen. Display screen 112 may take the form of a liquid crystal display (LCD), a light-emitting diode (LED) display, an organic light-emitting diode (OLED) display, a quantum dot (QD) display, or any other suitable display screen that perform a physical transformation of signals to light.

Lighting element(s) 114 of display 110 may be mounted on or adjacent to a ceiling of a venue including system 100, may include multiple light sources, and may be configured to provide light of varying intensity and varying colors, for example. For instance, lighting element(s) 114 may include small spotlights configured to provide directional lighting that can be turned on or off, or be selectively dimmed and brightened.

Haptic actuator(s) 116 of display 110 may have differing sizes and may be implemented so as to have differing orientations. For example, one or more of haptic actuators 116 may be implemented in a wall of a venue including system 100. Alternatively, or in addition, one or more haptic actuator(s) 116 may be embedded in or under a floor of such a venue. For example, haptic actuator(s) 116 embedded in or under a surface on which user 128 is standing can be utilized to produce haptic effects experienced by user 128 while user 128 interacts with system 100.

Audio speaker(s) 118 of display 110 may provide an indoor or outdoor audio system, such as a theater quality Dolby® high definition (HD) surround-sound system, for example. Moreover, in some implementations system 100 may include a library of stored audio recordings that can be played back through audio speaker(s). In some implementations, one or more of lighting element(s) 114, haptic actuator(s) 116 and audio speaker(s) 118 may be synchronized with display screen 112 to produce an immersive multi-media environment for user 128.

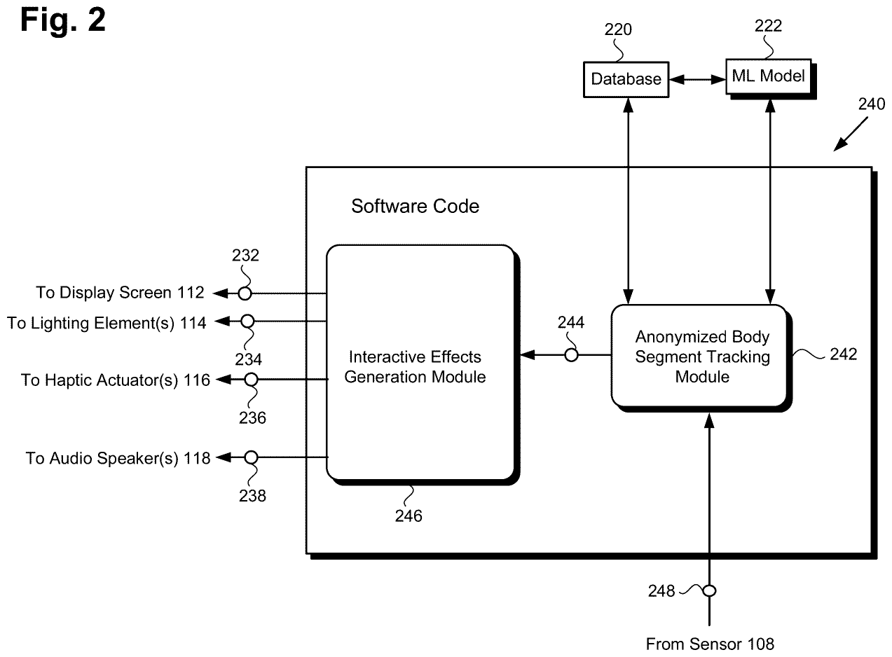

FIG. 2 shows a diagram of exemplary software code 240 suitable for use by anonymized human body tracking system 100, in FIG. 1, according to one implementation. As shown in FIG. 2, according to the present exemplary implementation, software code 240 includes anonymized body segment tracking module 242 and interactive effects generation module 246. As further shown in FIG. 2, anonymized body segment tracking module 242 of software code 240 may receive sensor data 248, from sensor 108 in FIG. 1, as input. Anonymized body segment tracking module 242 may use database 220, alone or in conjunction with trained ML model 222, to identify, using sensor data 248, respective locations of a plurality of physical features of a user being tracked by system 100, such as user 128 in FIG. 1.

In addition, anonymized body segment tracking module 242 may merge the respective locations of the plurality of physical features to determine position data 244 for at least one anonymized body segment of the user, and track changes in position data 244. Moreover, and as also shown in FIG. 2, software code 240 may provide display signal 232 as an output to display screen 112 of display 110, and in some implementations one or more of lighting signal 234 as an output to lighting element(s) 114 of display 110, haptic activation signal 236 to haptic actuator(s) 116 of display 110 and audio signal 238 as an output to audio speaker(s) 118 of display 110.

Software code 240, database 220 and trained ML model 222 correspond respectively in general to software code 140, database 120 and trained ML model 122, in FIG. 1. Thus, software code 140, database 120 and trained ML model 122 may share any of the characteristics attributed to respective software code 240, database 220 and trained ML model 222 by the present disclosure, and vice versa. As a result, and although not explicitly shown in FIG. 1, like software code 240, in FIG. 2, software code 140 includes features corresponding respectively to anonymized body segment tracking module 242 and interactive effects generation module 246.

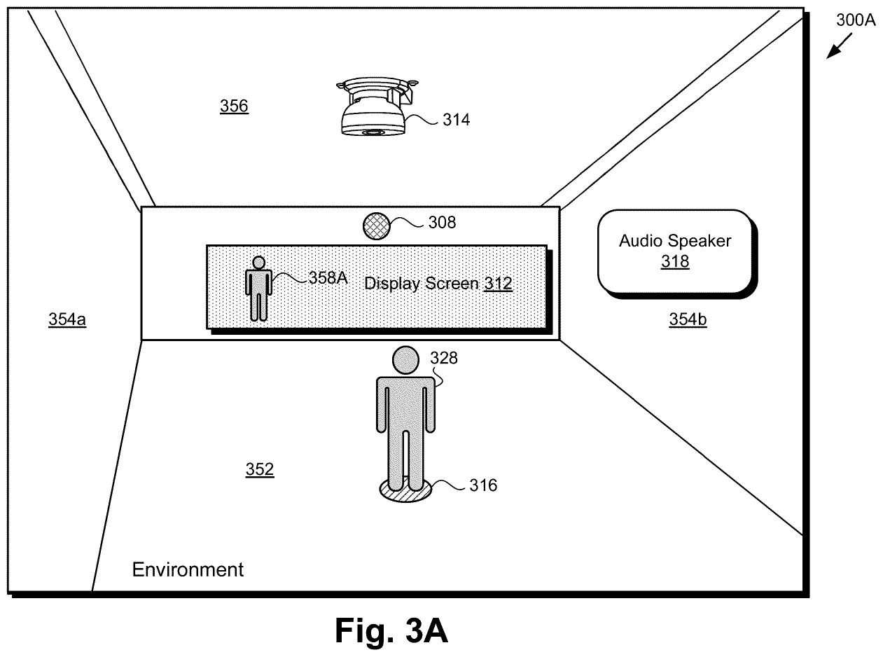

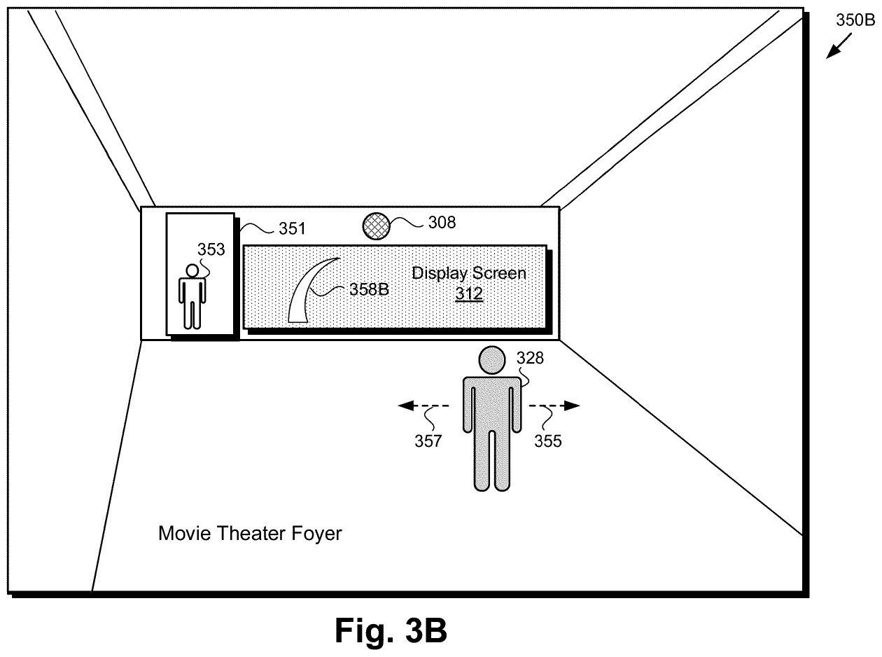

FIG. 3A shows exemplary environment 350A in which anonymized human body tracking is used to support an interactive user experience, according to one implementation. According to the exemplary implementation depicted in FIG. 3A, environment 350A is an indoor space, which may correspond to a movie theater, concert hall, cruise ship common area, museum, or any other enclosed space, and may include floor 352, walls 354a and 354b and ceiling 356. However, it is noted that in other implementations, environment 350A may be an outdoor space, such as an open air sports stadium or arena, the deck of a cruise ship, an outdoor stage, or a park, to name a few examples. As further shown in FIG. 3A, environment 350A includes sensor 308, display screen 312, lighting element 314, haptic actuator 316 and audio speaker 318. Also shown in FIG. 3A are interactive visual effect 358A rendered on display screen 312 and user 328 engaging with interactive visual effect 358A. It is noted that in contrast to many conventional body tracking techniques, the anonymized human body tracking solution disclosed in the present application does not require environment 350A to be a controlled environment such as a prepared room.

In some implementations, haptic actuator 316 may correspond to multiple haptic actuators having different sizes and implemented so as to have differing orientations. For example, a haptic actuator may be implemented in wall 354a and/or 354b. Alternatively, or in addition, one or more haptic actuators may be embedded in or under floor 352. For example, haptic actuator 316 embedded in or under floor 352 of environment 350A can be utilized to produce haptic effects experienced by user 328 engages with interactive visual effect 358A.

In some implementations, haptic actuators such as haptic actuator 316 may be oriented such that the haptic effects they produce are applied substantially perpendicular to the surfaces or objects in which they are situated. Thus, haptic actuators may be used to produce effects that are perceived by user 328 to be produced by walls 354a and/or 354b, and/or floor 352.

It is noted that the interactive experience supported by anonymized human body tracking depicted in FIG. 3A is provided by a system corresponding to system 100, in FIG. 1. That is to say, although not explicitly shown in FIG. 3A, and hidden from view of user 328, environment 350A includes a computing platform corresponding to computing platform 102 having hardware processor 104, and memory 106 storing software code 140, database 120 and trained ML model 122. Moreover, like computing platform 102, the computing platform of environment 350A is communicatively coupled to sensor 308, as well as to a display corresponding to display 110 in FIG. 1 and including display screen 312, lighting element 314, haptic actuator 316 and audio speaker 318.

Sensor 308, display screen 312, lighting element 314, haptic actuator 316 and audio speaker 318 correspond respectively in general to sensor 108, display screen 112, lighting element(s) 114, haptic actuator(s) 116 and audio speaker(s) 118, in FIG. 1. Consequently, sensor 308, display screen 312, lighting element 314, haptic actuator 316 and audio speaker 318 may share any of the characteristics attributed to respective sensor 108, display screen 112, lighting element(s) 114, haptic actuator(s) 116 and audio speaker(s) 118 by the present disclosure, and vice versa.

FIG. 3B shows exemplary environment 350B in which anonymized human body tracking is used to support an interactive user experience, according to another implementation. According to the exemplary implementation shown in FIG. 3B, environment 350B is an indoor space, and more specifically may be a foyer of a movie theater screening a movie promoted by poster or other artwork 351 featuring starring character 353 of the movie being screened. As further shown in FIG. 3B, environment 350B includes sensor 308 in the form of an RGB camera lacking a depth sensor, and display screen 312. In addition, FIG. 3B shows interactive visual effect 358B depicting a feature from the movie being promoted and screened, e.g., in the present use case an animated ocean wave (interactive visual effect 358B hereinafter also referred to as “interactive ocean wave 358B”), rendered on display screen 312. Also shown in FIG. 3B is user 328 engaging with interactive ocean wave 358B and opposite directions 355 and 357 in which user 328 may move while engaging with interactive ocean wave 358B.

It is noted that the interactive experience supported by anonymized human body tracking depicted in FIG. 3B is provided by a system corresponding to system 100, in FIG. 1. That is to say, although not explicitly shown in FIG. 3B, and hidden from view of user 328, environment 350B includes a computing platform corresponding to computing platform 102 having hardware processor 104, and memory 106 storing software code 140, database 120 and trained ML model 122. Moreover, like computing platform 102, the computing platform of environment 350B is communicatively coupled to sensor 308, as well as to display screen 312.

It is further noted that any feature in FIG. 3B identified by a reference number identical to a reference number used to identify a feature in FIG. 3A corresponds respectively in general to that previously described feature and may share any of the characteristics attributed to that corresponding feature by the present disclosure. It is also noted that the system supporting the interactive experience in environment 350B differs from the system supporting the interactive experience in environment 350A in that, unlike the system supporting the interactive experience environment 350A, the system supporting the interactive experience in environment 350B omits a lighting element or lighting elements corresponding to lighting element 314, a haptic actuator or haptic actuators corresponding to haptic actuator 316 and an audio speaker or audio speakers corresponding to audio speaker 318.

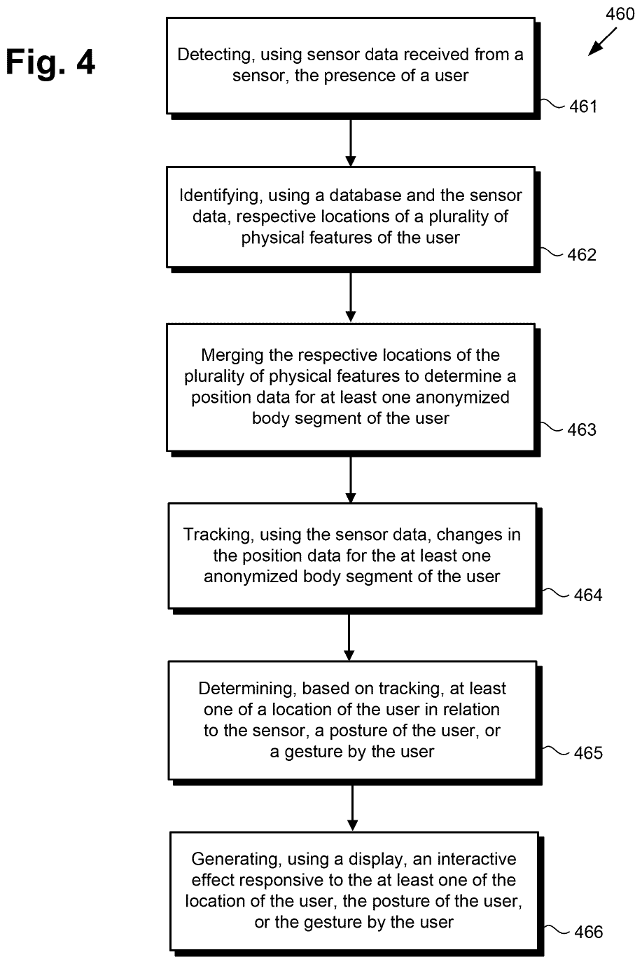

According to the exemplary implementation shown in FIG. 3B, when the anonymized human body tracking system that includes sensor 308 detects the presence of user 328, as described in greater detail below by reference to FIG. 4, interactive ocean wave 358B is rendered on display screen 312 such that interactive ocean wave 358B appears to be looking at user 328. For example, and as shown in FIG. 3B user 328 is located in direction 355 relative to interactive ocean wave 358B, and interactive ocean wave 358B appears to be looking toward user 328 in direction 355. If user 328 moves in direction 357, the apparent gaze of interactive wave 358B will appear to shift in direction 357 as well, in order to continue to be looking toward user 328. Other actions by user 328 may result in other interactive effects by interactive ocean wave 358B. For example, if user 328 raises both arms, interactive ocean wave 358B may appear to generate a splash of water that is rendered on display screen 312.

The functionality of system 100 will be further described by reference to FIG. 4, which shows flowchart 460 presenting an exemplary method for performing anonymized human body tracking, according to one implementation. With respect to the method outlined in FIG. 4, it is noted that certain details and features have been left out of flowchart 460 in order not to obscure the discussion of the inventive features in the present application.

Referring to FIG. 4 in combination with FIGS. 1, 2, 3A and 3B, flowchart 460 begins with detecting, using sensor data 248 received from sensor 108/308, the presence of user 128/328 (action 461). In some implementations, sensor 108/308 may take the form of a single RGB camera, such as an RGB webcam or other type of RGB video camera, for example, and may lack a depth sensor. Nevertheless, the proximity of user 128/328 to sensor 108/308 may be estimated based on comparison of a detected height and/or shoulder width of user 128/328, for example, with average human body dimensions. When distance 130 separating sensor 108/308 facing user 128/328 is estimated to be within a predetermined distance threshold, user 128/328 may be detected as being “present” for the purposes of engagement with interactive visual effect 358A/358B.

Sensor 108/308 may be wirelessly connected to computing platform 102, or may be connected to computing platform 102 via a wired connection. That is to say, communication links 126 may be wired or wireless communication links, or a combination of wired and wireless communication links. Moreover, although in some implementations sensor 108/308 may take the form of a single RGB camera lacking a depth sensor, in other implementations, sensor 108/308 may include a plurality of sensors including one or more of cameras, microphones and depth sensors. Detection of the presence of user 128/328 in action 461 may be performed by software code 140/240, executed by hardware processor 104 of computing platform 102.

Continuing to refer to FIGS. 1, 2, 3A, 3B and 4 in combination, Flowchart 460 further includes identifying, using database 120/220 and sensor data 248, respective locations of a plurality of physical features of user 128/328 (action 462). As noted above, database 120/220 stores images corresponding respectively to human physical features. The physical features of user 128/328 identified in action 462 may be predetermined, and may vary according to the one or more anonymized body segments of user 128/328 to be tracked.

For example, where the one or more anonymized body segments of user 128/328 to be tracked includes the head of user 128/328, the features of user 128/328 identified in action 462 may include any combination of the eyes, ears, nose, mouth and chin of user 128/328, to name a few examples. Alternatively, or in addition, where the one or more anonymized body segments of user 128/328 to be tracked includes the torso of user 128/328, the features of user 128/328 identified in action 462 may include any combination of the shoulders, arms and waistline of user 128/328, again to name a few examples. Alternatively, or in addition, in implementations in which one or more gestures by the user are to be tracked, the features of user 128/328 identified in action 462 may include one or both hands of user 128/328.

It is noted that in some implementations, trained ML model 122/222 may be trained as a feature detector. In those implementations, the identification of the respective locations of the plurality of features of user 128/328 may be performed, in action 462, using trained ML model 122/222 in conjunction with database 120/220. Action 462 may be performed by software code 140/240, executed by hardware processor 104 of computing platform 102.

Continuing to refer to FIGS. 1, 2, 3A, 3B and 4 in combination, Flowchart 460 further includes merging the respective locations of the plurality of physical features identified in action 462 to determine position data 244 for one or more anonymized body segments of user 128/328 (action 463). The anonymized one or more body segments of user 128/328 for which position data 244 is determined in action 463 may include one or more of the head of user 128/328, the torso of user 128/328, and one or both hands of user 128/328. In implementations in which the one or more anonymized body segments of user 128/328 includes the head of user 128/328, position data 244 may be an average of the locations of the plurality of features of the head of user 128/328 identified in action 462, such as a central location between the ears of user 128/328, for example.

Analogously, in implementations in which the one or more anonymized body segments of user 128/328 includes the torso of user 128/328, position data 244 may be an average of the locations of the plurality of features of the torso of user 128/328 identified in action 462, while in implementations in which the one or more anonymized body segments of user 128/328 includes the hands of user 128/328, position data 244 may be an average of the locations of each hand. The merging of the respective locations of the plurality of physical features identified in action 462 to determine position data 244 for one or more anonymized body segment of user 128/328, in action 463, may be performed by software code 140/240, executed by hardware processor 104 of computing platform 102, and using anonymized body segment tracking module 242.

As noted above, in some implementations, the physical features for which respective locations are identified in action 462 may be predetermined. However, in some use cases, due to turning of the head by user 128/328 for example, locations for all of those predetermined features may not be identifiable based on sensor data 248. For example, the predetermined features may include both eyes and both ears of user 128/328 but user 128/328 may turn their head so that the location of only one eye and/or one ear may be identifiable in action 462. In such edge cases, software code 140/240 is configured to determine position data 244, in action 463, when less than all of the respective locations of the predetermined physical features are identified in action 462.

Continuing to refer to FIGS. 1, 2, 3A, 3B and 4 in combination, Flowchart 460 further includes tracking, using sensor data 248, changes in position data 244 for the one or more anonymized body segments of user 128/328 (action 464). Tracking the changes in position data 244, in action 464 may be performed by software code 140/240, executed by hardware processor 104 of computing platform 102, and using anonymized body segment tracking module 242. It is emphasized that because position data 244 describes the location of one or more anonymized body segments of user 128/328, rather than the locations or other characteristics of individually recognizable features of user 128/328, position data 244 advantageously omits any PII of user 128/328. Moreover, because position data 244 is determined by system 100 functioning as a closed system, position data 244 is not transmitted outside of memory 106 of computing platform 102, thereby further ensuring privacy protection for and anonymity of user 128/328.

Continuing to refer to FIGS. 1, 2, 3A, 3B and 4 in combination, Flowchart 460 further includes determining, based on the tracking performed in action 464, at least one of a location of user 128/328 in relation to sensor 108/308, a posture of user 128/328, or a gesture by user 128/328 (action 465). For example, the tracking performed in action 464 may detect a shift in the location of user 128/328 closer to or farther from sensor 108/308, or movement to the right or left within the field-of-view of sensor 108/308. As another example, where tracking detects a reduction in the elevation of position data 244 for the head and/or torso of user 128/328, system 100 may determine that user 128/328 is crouching or bending. As yet another example, where tracking detects that position data 244 for both hands is elevated, raised arms by user 128/328 may be detected, while elevation in position data 244 for one hand may be used to detect gesturing by user 128/328, such as hand waving by user 128/328. The determination of the at least one of the location of user 128/328 in relation to sensor 108/308, the posture of user 128/328, or the gesture by user 128/328, in action 465, may be performed by software code 140/240, executed by hardware processor of computing platform 102, and using anonymized body segment tracking module 242.

Continuing to refer to FIGS. 1, 2, 3A, 3B and 4 in combination, Flowchart 460 further includes generating, using display 110, an interactive effect, e.g., interactive visual effect 358A/358B, responsive to the at least one of the location user 128/328, the posture of user 128/328, or the gesture by user 128/328 (action 466). It is noted that although FIGS. 3A and 3B depict interactive visual effect 358A/358B, in various implementations, the interactive effect generated in action 466 may include one or more visual effects, one or more audio effects, one or more lighting effects, one or more haptic effects, or any combination thereof. Moreover, where the interactive effect generated in action 466 includes one or more visual effects, that/those visual effects may be rendered as two-dimensional (2-D) images, three-dimensional (3-D) images, and/or may be rendered as AR or VR effects.

The generation of the interactive effect in action 466 may be performed by software code 140/240, executed by hardware processor 104 of computing platform 102, and using interactive effects generation module 246. By way of example, software code 140/240 may use anonymized body segment tracking module 242 to provide position data 244 to interactive effects generation module 246 at sixty (60) frames-per-second, and interactive effects generation module may output the generated interactive effect to display 110 using any suitable communication protocol, such as the Open Sound Control (OSC) protocol for example. Alternatively, in some implementations the generated interactive effect may be output to display 110 by being streamed to display 110.

According to all implementations of the present inventive concepts, the interactive effect generated by system 100 in action 466 may advantageously be rendered by display 110 in real-time with respect to a change in location or posture by user 128/328, or in response to a gesture by user 128/328. As noted above, as defined in the present application, “real-time” refers to the absence of humanly perceived latency between a user action and a system generated interactive response to that action. With respect to the method outlined by FIG. 4, it is noted that in some implementations, actions 461, 462, 463, 464, 465 and 466 may be performed in an automated process from which human involvement may be omitted.

Thus, the present application discloses systems and methods for performing anonymized human body tracking that address and overcome the drawbacks and deficiencies in the conventional art by enabling real-time interactive responsiveness to human behavior while ensuring the anonymity of users participating in an interactive experience. The present anonymized human body tracking solution advances the state-of-the-art by averaging body features to preserve privacy and anonymity, can advantageously be executed using off-the-shelf equipment rather than bespoke technology while nevertheless enabling gesture detection as well as body tracking, and additionally determines body distance without access to actual distance/depth data.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

1. An interactive system comprising:
a computing platform communicatively coupled to a sensor and a display;
the computing platform having a hardware processor and a memory storing a software code and a database comprising images corresponding respectively to human physical features;
the hardware processor configured to execute the software code to:
detect, using sensor data received from the sensor, a presence of a user;
identify, using the database and the sensor data, respective locations of a plurality of physical features of the user;
average the respective locations of the plurality of physical features to determine a position data for at least one anonymized body segment of the user;
track, using the sensor data, changes in the position data for the at least one anonymized body segment of the user;
determine, based on tracking, at least one of a location of the user in relation to the sensor, a posture of the user, or a gesture by the user; and
generate, using the display, an interactive effect responsive to the at least one of the location of the user, the posture of the user, or the gesture by the user.

2. The interactive system of claim 1, wherein the position data omits any personally identifiable information about the user.

3. The interactive system of claim 1, wherein the sensor is a red-green-blue (RGB) camera lacking a depth sensor, the display is a display screen, and the interactive effect depicts a visual feature from a movie.

4. The interactive system of claim 1, wherein the display comprises an augmented reality device or a virtual reality device.

5. The interactive system of claim 1, wherein the display comprises at least one of a display screen, a lighting element, an audio speaker, or a haptic actuator.

6. The interactive system of claim 1, wherein the plurality of physical features of the user being tracked are predetermined physical features.

7. The interactive system of claim 1, wherein the interactive system further comprises a trained machine learning (ML) model, and wherein identify the respective locations of the plurality of physical features of the user is performed further using the trained ML model.

8. The interactive system of claim 1, wherein the plurality of physical features of the user being tracked are predetermined physical features, and wherein the software code is configured to determine the position data for the at least one anonymized body segment of the user when less than all of the respective locations of the predetermined physical features are identified.

9. The interactive system of claim 1, wherein the at least one anonymized body segment of the user comprises one or more of a head of the user or a torso of the user.

10. The interactive system of claim 1, wherein the at least one anonymized body segment of the user comprises one or both hands of the user.

11. A method for use by an interactive system including a computing platform communicatively coupled to a sensor and a display, the computing platform having a hardware processor and a memory storing a software code and a database comprising images corresponding respectively to human physical features, the method comprising:
detecting, by the software code executed by the hardware processor and using sensor data received from the sensor, a presence of a user;
identifying, by the software code executed by the hardware processor and using the database and the sensor data, respective locations of a plurality of physical features of the user;
averaging, by the software code executed by the hardware processor, the respective locations of the plurality of physical features to determine a position data for at least one anonymized body segment of the user;
tracking, by the software code executed by the hardware processor and using the sensor data, changes in the position data for the at least one anonymized body segment of the user;
determining, by the software code executed by the hardware processor, based on tracking, at least one of a location of the user in relation to the sensor, a posture of the user, or a gesture by the user; and
generating, by the software code executed by the hardware processor and using the display, an interactive effect responsive to the at least one of the location of the user, the posture of the user, or the gesture by the user.

12. The method of claim 11, wherein the position data omits any personally identifiable information about the user.

13. The method of claim 11, wherein the sensor is a red-green-blue (RGB) camera lacking a depth sensor, the display is a display screen, and the interactive effect depicts a visual feature from a movie.

14. The method of claim 11, wherein the display comprises an augmented reality device or a virtual reality device.

15. The method of claim 11, wherein the display comprises at least one of a display screen, a lighting element, an audio speaker, or a haptic actuator.

16. The method of claim 11, wherein the plurality of physical features of the user being tracked are predetermined physical features.

17. The method of claim 11, wherein the interactive system further comprises a trained machine learning (ML) model, and wherein identify the respective locations of the plurality of physical features of the user is performed further using the trained ML model.

18. The method of claim 11, wherein the plurality of physical features of the user being tracked are predetermined physical features, and wherein the software code is configured to determine the position data for the at least one anonymized body segment of the user when less than all of the respective locations of the predetermined physical features are identified.

19. The method of claim 11, wherein the at least one anonymized body segment of the user comprises one or more of a head of the user or a torso of the user.

20. The method of claim 11, wherein the at least one anonymized body segment of the user comprises one or both hands of the user.
